(19) United States
(12) Patent Application Publication
(10) Pub. No.: US 2006/0198264 A1
(43) Pub. Date: Sep. 7, 2006

(54) Optical disk device and optical disk determination method

(76) Inventors: Masashi Ueno, Tokyo (JP); Yasushi Higashiyama, Yokohama-shi (JP); Hiroharu Satoh, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/342,338

(22) Filed: Jan. 27, 2006

(30) Foreign Application Priority Data
Jan. 28, 2005 (JP) 2005-021850

(51) Int. Cl. G11B 7/095

(52) U.S. Cl. 369/53.22

(57) ABSTRACT

An optical disk device includes first pickup portion PU1 which outputs first detection signal by irradiating first laser beam having first wavelength to surface of optical disk and receiving its reflected light, second pickup portion PU2 having independent structure, which irradiates second laser beam having second wavelength and receives its reflected light so as to output second detection signal, and control portion in which with the first laser beam and the second laser beam so as to receive the first detection signal and the second detection signal, when system data of first class disk system area is detected from the first detection signal, the optical disk is determined to be the first class disk and when system data of second class disk system area is detected from the second detection signal, that optical disk is determined to be the second class.

### CROSS-REFERENCE TO RELATED APPLICATIONS

This application is based upon and claims the benefit of priority from prior Japanese Patent Application No. 2005-021850, filed Jan. 28, 2005, the entire contents of which are incorporated herein by reference.

### BACKGROUND

1. Field

The present invention relates to an optical disk device and optical disk determination method and more particularly to an optical disk device and optical disk determination method for determining the kind of HD DVD and DVD.

2. Description of the Related Art

Recently, the optical disk as information recording medium has been very widely adopted and for example, compact disk (CD), digital versatile disk (DVD), high definition digital versatile disk (HD DVD) standardized as a recording medium of high vision class pictures and the like have been well known. These disks are not so different in external shape and can be recorded or reproduced by the same driver. At this time, the kind of the disk needs to be determined securely and quickly and therefore, a variety of technologies have been well known.

The patent document 1 (Jpn. Pat. Appln. KOKAI Publication No. 2001-23287) has disclosed technology of determining the kind of disk (CD, DVD) by irradiating laser beams each having a different wavelength from a CD light source and DVD light source and detecting a total addition signal of a detection signal and RF envelope based on a difference in reflectance or the like.

However, the conventional technology of the patent document 1 has such a problem that the HD DVD whose physical property is not so different from the DVD in terms of the reflectance and the like is difficult to distinguish from the DVD because the conventional technology makes the determination based on the total addition signal of a detection signal and the RF envelope.

### BRIEF SUMMARY OF THE INVENTION

According to one embodiment of the present invention, there is provided an optical disk device comprising: a first pickup portion which irradiates a first laser beam having a first wavelength to a surface of an optical disk and receives a reflected light so as to output a first detection signal; a second pickup portion having an independent structure from the first pickup portion, which irradiates a second laser beam having a second wavelength to the surface of the optical disk and receives a reflected light so as to output a second detection signal; and a control portion in which with the first laser beam and the second laser beam irradiated from the first pickup portion and the second pickup portion so as to receive the first detection signal and the second detection signal, when system data of a first class disk system area is detected from the first detection signal, the optical disk is determined to be the first class disk and when system data of a second class disk system area is detected from the second detection signal, the optical disk is determined to be the second class disk so as to make control depending on a determination result.

### BRIEF DESCRIPTION OF THE SEVERAL VIEWS OF THE DRAWINGS

FIG. 1 is a diagram showing an example of the structure of a first disk device according to an embodiment of the present invention;

FIG. 2 is a diagram showing an example of the structure of a second disk device according to an embodiment of the present invention;

FIG. 3 is a flow chart showing an example of disk determination processing of the first disk device according to the embodiment of the present invention;

FIG. 4 is a flow chart showing an example of disk determination processing of the second disk device according to the embodiment of the present invention;

FIG. 5 is a flow chart showing another example of disk determination processing of the second disk device according to the embodiment of the present invention;

FIG. 6 is an explanatory diagram picking up an example of comparison between the HD DVD and current DVD in terms of dimension;

FIG. 7 is an explanatory diagram showing an example of data structure of a lead-in area of the HD DVD;

FIG. 8 is an explanatory diagram showing mechanical dimensions of the HD DVD;

FIG. 9 is an explanatory diagram showing data arrangement within control data zone in the HD DVD;

FIG. 10 is an explanatory diagram showing the content of information within physical format of the HD DVD;

FIG. 11 is an explanatory diagram showing a format of the standard type and part version BP 0 within the physical format information in the HD DVD;

FIG. 12 is an explanatory diagram showing a format of disk size and disk maximum transmission speed BP 1 within the physical format information in the HD DVD;

FIG. 13 is an explanatory diagram showing the format of the disk structure BP 2 within the physical format information in the HD DVD;

FIG. 14 is an explanatory diagram showing the format of recording density BP 3 within the physical format information in the HD DVD;

FIG. 15 is an explanatory diagram showing the content of data allocation information in the HD DVD;

FIG. 16 is an explanatory diagram showing the format of BCA descriptor BP 16 within the physical format information in the HD DVD;

FIG. 17 is an explanatory diagram showing data structure of a lead-in area of a current DVD;

FIG. 18 is an explanatory diagram showing data arrangement within control data of the current DVD;

FIG. 19 is an explanatory diagram showing the content of information within the physical format of the current DVD; and

FIG. 20 is an explanatory diagram showing BP0 standard type and part type of the current DVD.

### DETAILED DESCRIPTION

Hereinafter, the preferred embodiments of the present invention will be described in detail with reference to the accompanying drawings.

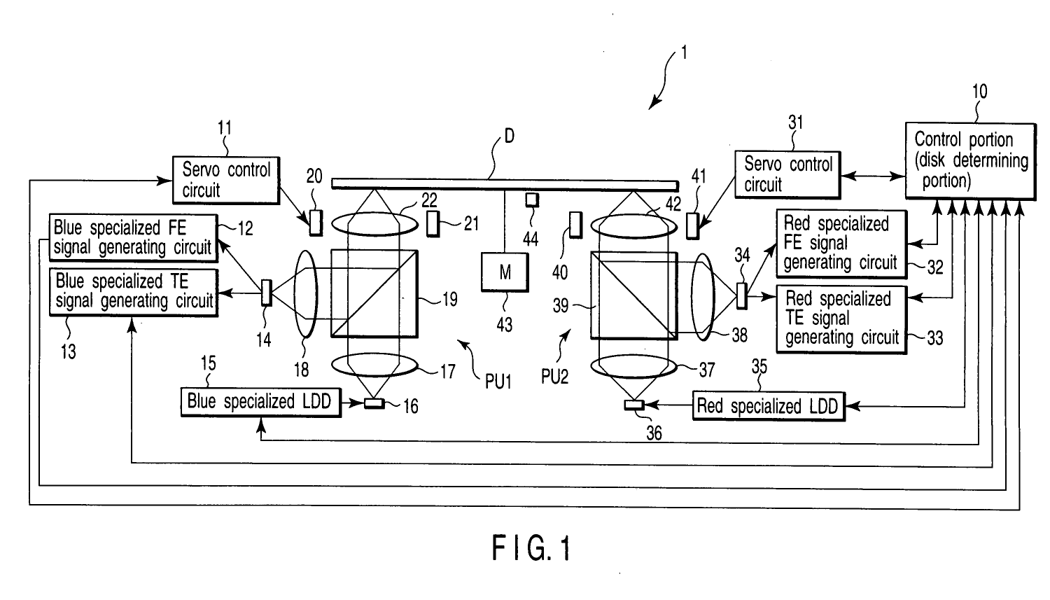

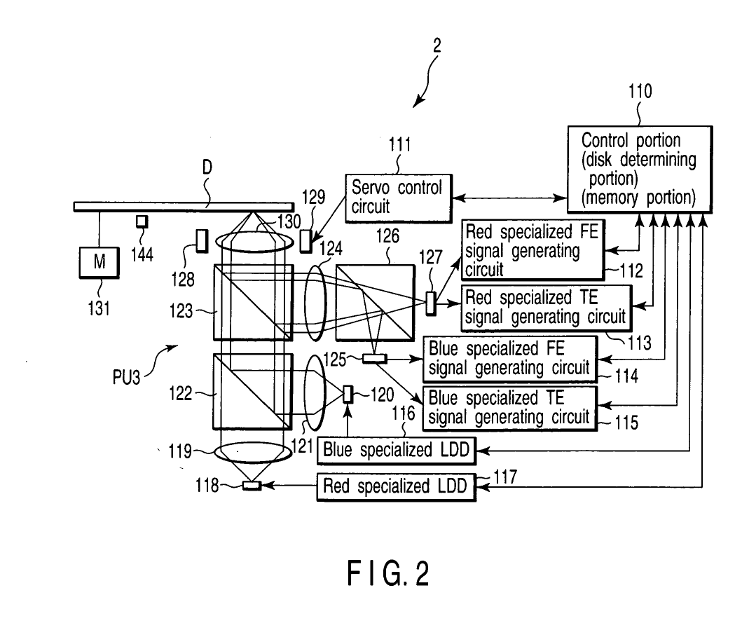

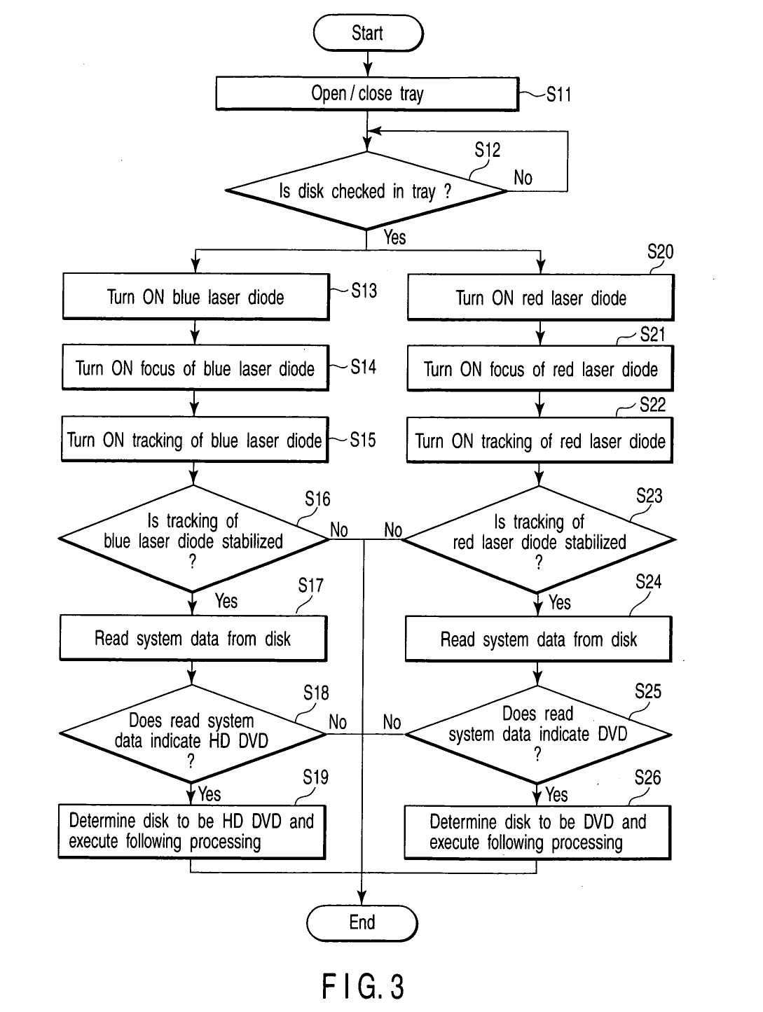

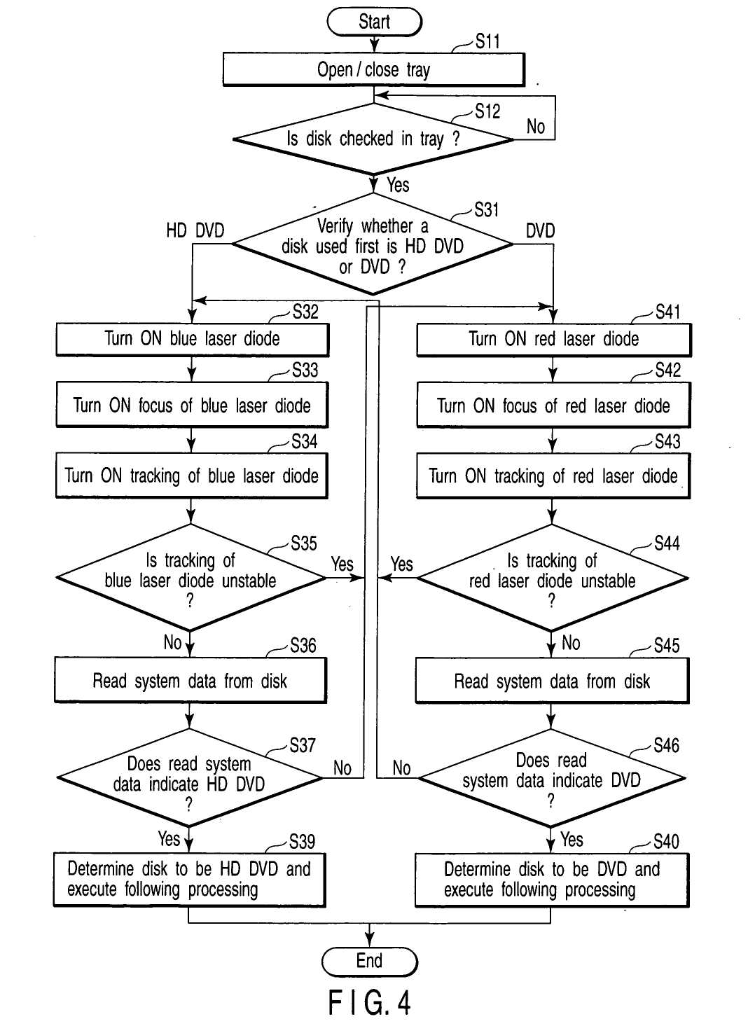

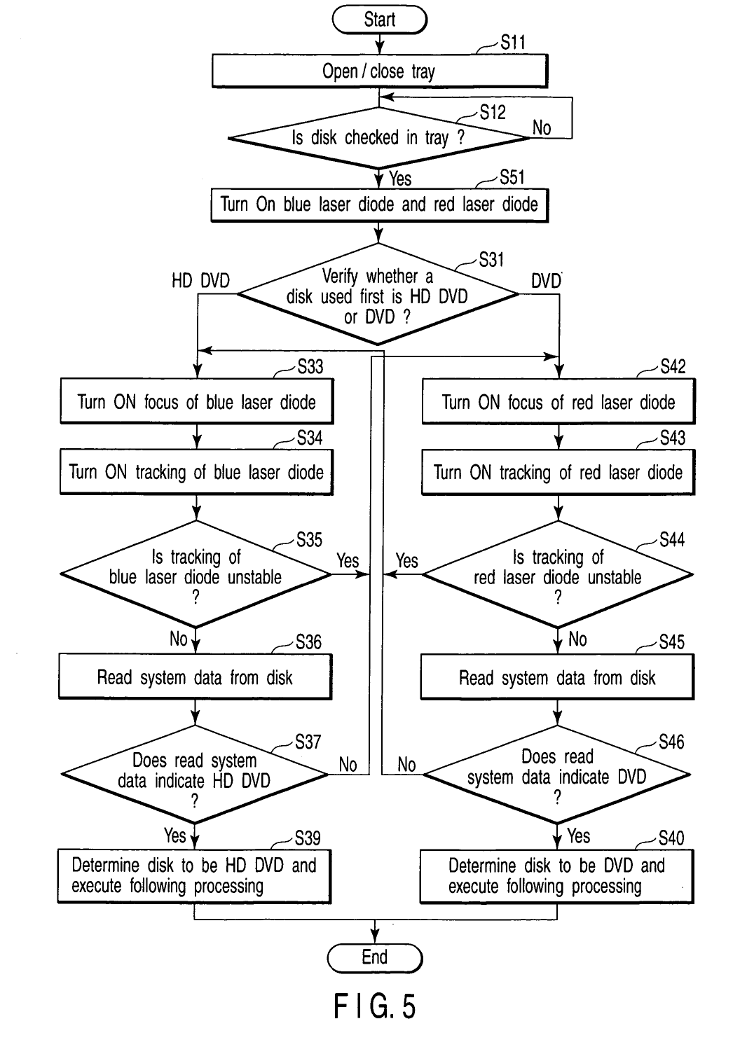

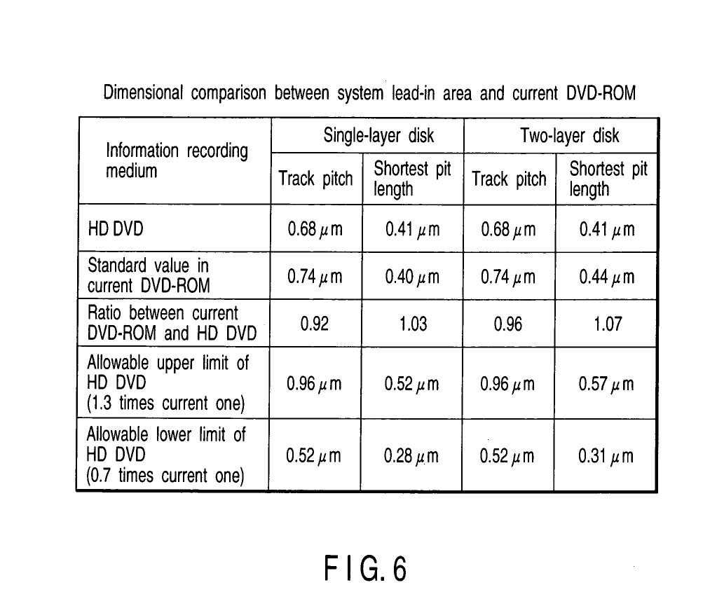

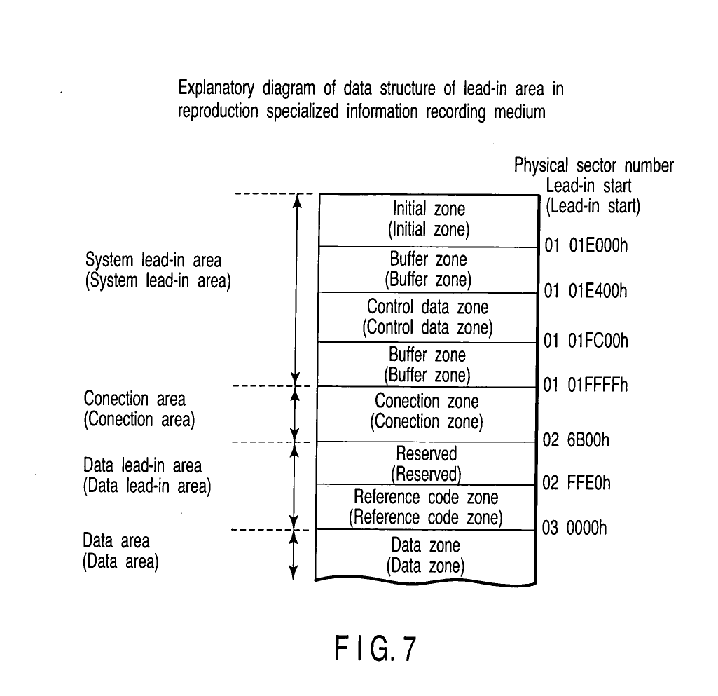

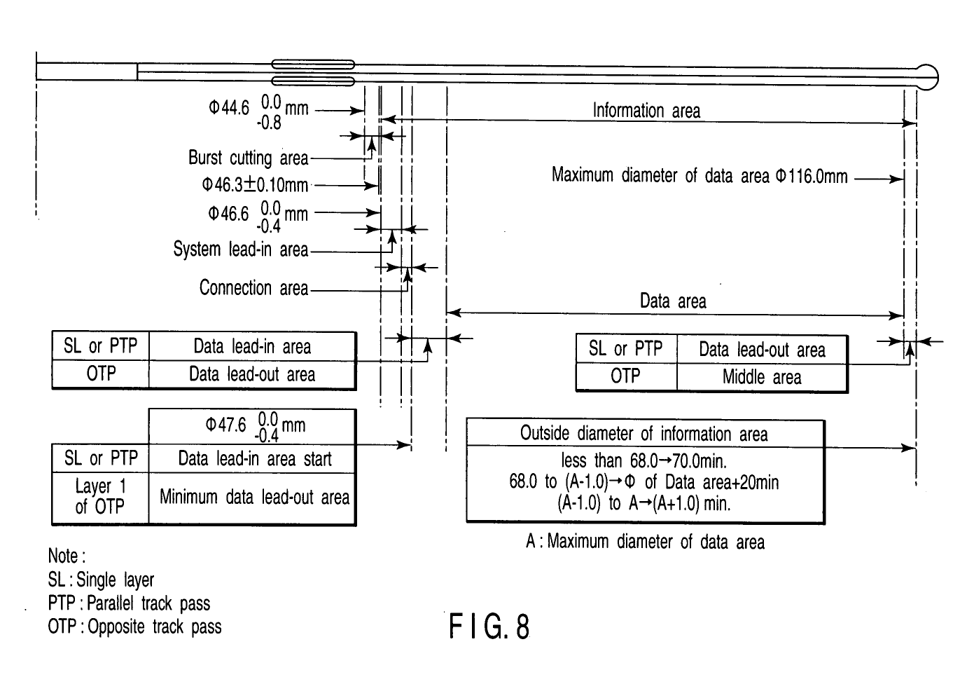

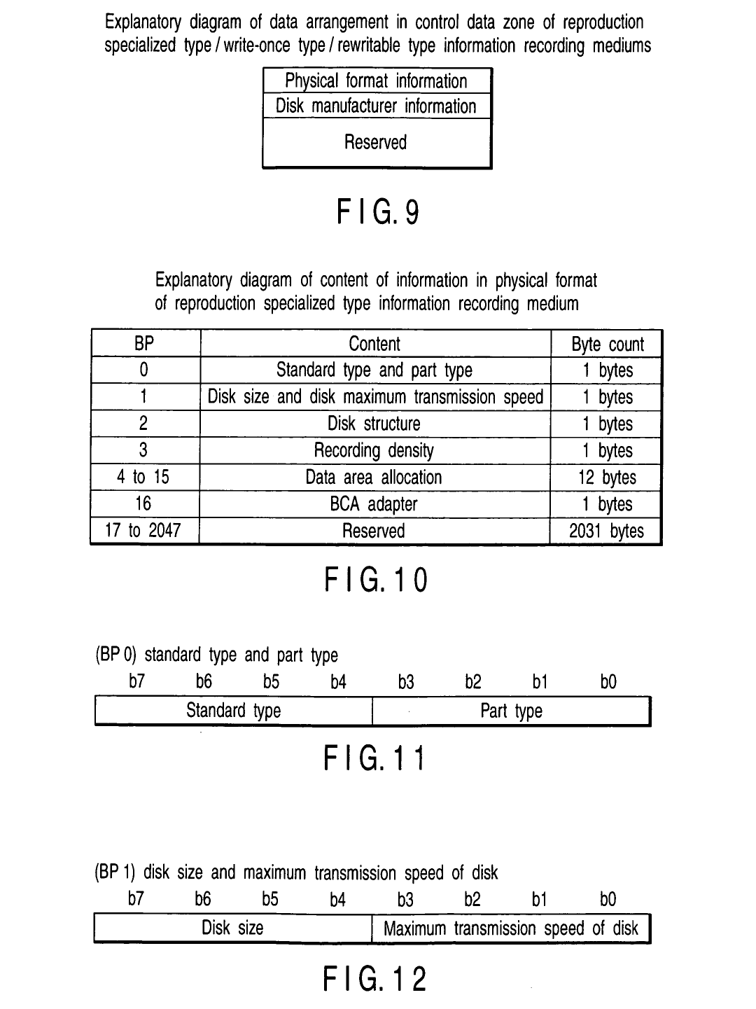

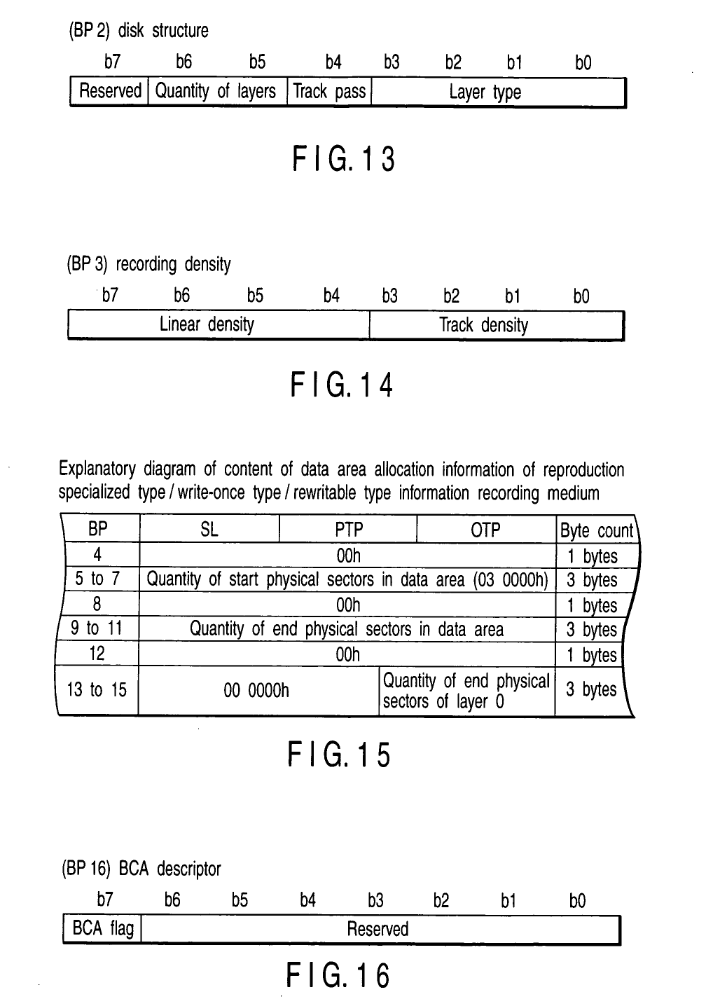

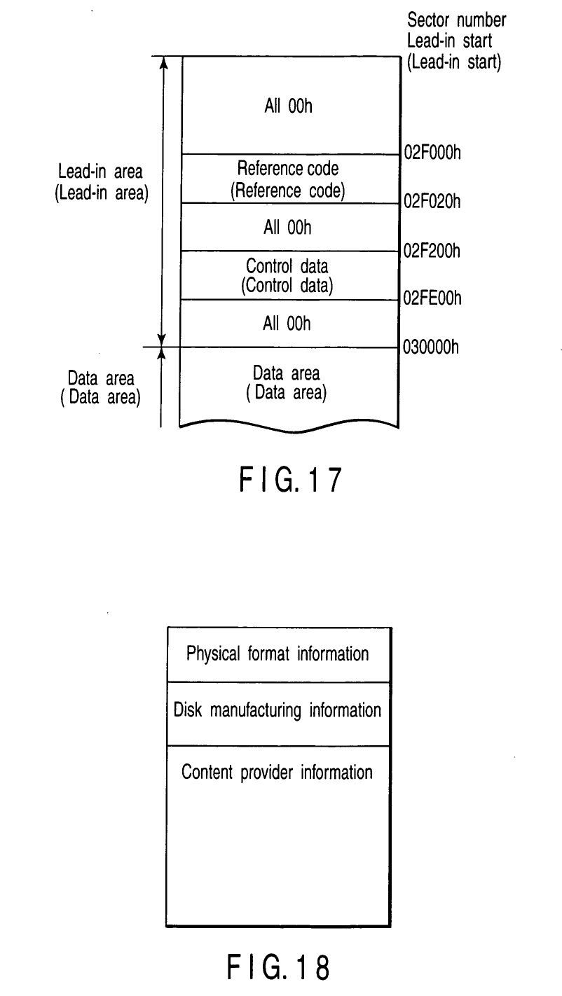

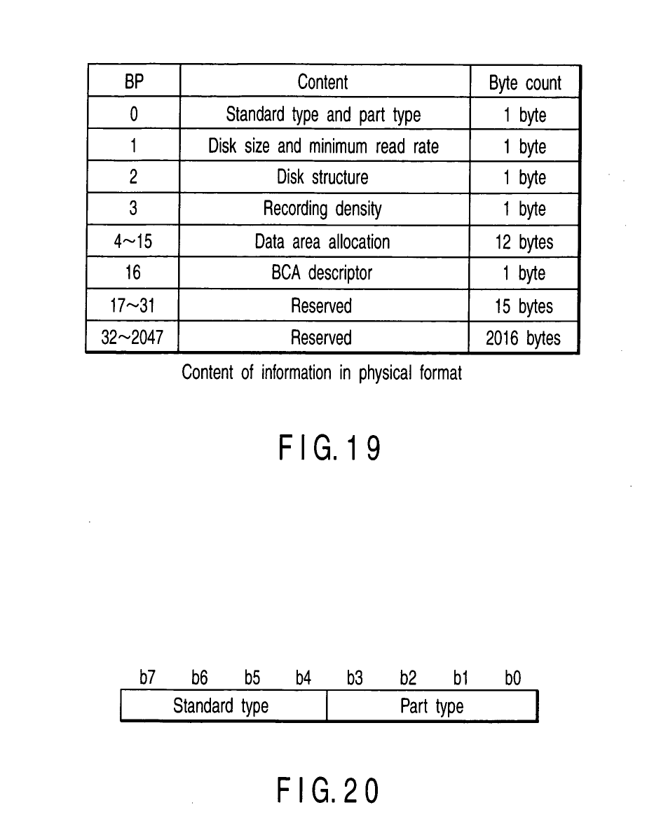

FIG. 1 is a diagram showing an example of the structure of a first disk device according to an embodiment of the present invention; FIG. 2 is a diagram showing an example of the structure of a second disk device according to an embodiment of the present invention; FIG. 3 is a flow chart showing an example of disk determination processing of the first disk device according to the embodiment of the present invention; FIG. 4 is a flow chart showing an example of disk determination processing of the second disk device according to the embodiment of the present invention; FIG. 5 is a flow chart showing another example of the disk determination processing of the second disk device according to the embodiment of the present invention; FIG. 6 is an explanatory diagram picking up an example of comparison between the HD DVD and current DVD in terms of dimension; FIG. 7 is an explanatory diagram showing an example of data structure of a lead-in area of the HD DVD; FIG. 8 is an explanatory diagram showing mechanical dimensions of the HD DVD; FIG. 9 is an explanatory diagram showing data arrangement within control data zone in the HD DVD; FIG. 10 is an explanatory diagram showing the content of information within physical format of the HD DVD; FIG. 11 is an explanatory diagram showing a format of the standard type and part version BP 0 within the physical format information in the HD DVD; FIG. 12 is an explanatory diagram showing a format of disk size and disk maximum transfer speed BP 1 within the physical format information in the HD DVD; FIG. 13 is an explanatory diagram showing the format of the disk structure BP 2 within the physical format information in the HD DVD; FIG. 14 is an explanatory diagram showing the format of recording density BP 3 within the physical format information in the HD DVD; FIG. 15 is an explanatory diagram showing the content of data allocation information in the HD DVD; FIG. 16 is an explanatory diagram showing the format of BCA descriptor BP 16 within the physical format information in the HD DVD; FIG. 17 is an explanatory diagram showing data structure of a lead-in area of a current DVD; FIG. 18 is an explanatory diagram showing data arrangement within control data of the current DVD; FIG. 19 is an explanatory diagram showing the content of information within the physical format of the current DVD; and FIG. 20 is an explanatory diagram showing BP0 standard type and part type of the current DVD.

### OPTICAL DISK DEVICE ACCORDING TO AN EMBODIMENT OF THE PRESENT INVENTION

### First Embodiment

A first embodiment relates to an optical disk device which determines the kind of optical disk based on system data by irradiating different laser beams from independent optical pickups at the same time and detecting system data of the optical disk from a detection signal based on its reflection light. First, an embodiment of the optical disk device loaded with two optical pickups will be described in detail referring to the drawings.

(Structure)

A optical disk device 1 according to an embodiment of the present invention is loaded with two pickups specialized for red LED and blue LD as shown in FIG. 1. That is, the optical disk device 1 includes a control portion 10 which controls the entire operation and contains a determining portion about the kind of a disk and further a first pickup PU1 for blue laser and a second pickup PU2 for red laser. The optical disk device includes a spindle motor 43 which rotates an optical disk D at a predetermined speed and a spindle motor drive circuit (not shown).

The first pickup PU1 for blue laser is connected to this control portion 10 and has a laser diode 16 for blue laser (405 nm) for HD DVD, a collimator lens 17, a polarized beam splitter 19, an objective lens 22, a condenser lens 18 and a light detector 14. Further, it has lens actuators 20, 21 for the objective lens 22.

Here, a blue specialized laser diode driver 15 is controlled by the control portion 10 so as to drive the laser diode 16 and further, a detection signal from the light detector 14 is supplied to a blue specialized focus error (FE) signal generating circuit 12 and blue specialized tracking error (TE) signal generating circuit 13. Each of these supplies a focus error signal and tracking error signal to the control portion 10.

Likewise, the second pickup PU2 for red laser is connected to this control portion 10 and has a laser diode 36 for red laser (650 nm) for DVD (780 nm for CD), a collimator lens 37, a polarized beam splitter 39, an objective lens 42, a condenser lens 38 and a light detector 34 Further, it has lens actuators 40, 42 for the objective lens 42.

Here, a red specialized laser diode driver 35 is controlled by the control portion 10 so as to drive the laser diode 36 and further, a detection signal from the light detector 34 is supplied to a red specialized focus error (FE) signal generating circuit 32 and red specialized tracking error (TE) signal generating circuit 33. Each of these supplies a focus error signal and tracking error signal to the control portion 10.

Although a case where the two optical pickups PU1, PU2 have two light sources each having a different wavelength will be described, the quantity of pickups increases if three or more light sources each having a different wavelength (for example, for CD) are provided.

The optical pickups PU1, PU2 irradiate one or both of blue laser and red laser each having a different wavelength to the optical disk. Although as an example of the respective light sources, a first wavelength is represented near 405 nm (HD DVD) and a second wavelength is represented near 660 nm (DVD), it is preferable to irradiate beam of a third wavelength near 785 nm (CD). Further, it is also preferable that the first laser beam is 440 nm or less, the second laser beam is 600 to 700 nm and the third laser beam is 700 nm or more.

In the optical pickup device PU1, blue laser beam irradiated from the blue laser diode 16 is turned to parallel light by the collimator lens 17 and focused by the objective lens 22, entering an optical disk D. The incident light from the surface of the optical disk is focused on a recording/reproduction layer face while reflected light passes through the objective lens 22 via an opposite route to the foregoing one and is reflected by the polarized beam splitter 19. The reflected light is focused by the condenser lens 18 and received by the light detector 14.

The same operation is performed in the optical pickup device PU2. Red laser beam irradiated from the red laser diode 17 is turned to parallel light by the collimator lens 37 and focused by the objective lens 42, entering an optical disk D. After entering on the surface of the optical disk, reflected light passes through the objective lens 42 and is reflected by the polarized beam splitter 39. The reflected light is focused by the condenser lens 38 and received by the light detector 34.

Detection signals detected from the light detector 14 and the light detector 34 are supplied to the blue specialized FE signal generating circuit 12, the blue specialized TE signal generating circuit 13, the red specialized FE signal generating circuit 32 and the red specialized TE signal generating circuit 33 respectively. Then, a control amount is determined by the control portion 10 depending on the magnitude of each focus error signal and each tracking error signal. This control amount is supplied to servo control circuits 11, 31 of the respective pickups PU1, PU2 so as to carry out focus control and tracking control of the pickups PU1, PU2 via actuators 20, 21, 40, 41. In this way, the servo controls of the pickups PU1, PU2 are achieved.

(Determination Processing on the Kind of Optical Disk)

Next, an example of the determination processing on the kind of the optical disk according to an embodiment of the present invention will be described with reference to related drawings. First, a disk tray (not shown) is opened/closed (S11). Then, if a sensor 44 senses that a disk is inserted (S12), the blue laser diode is turned ON (S13) and the red laser diode is turned ON (S20). The tracking of the blue laser diode is turned ON aiming at a control data zone of lead-in area of the DVD (S15) and the focus of the red laser diode is turned ON (S21) and the tracking of the red laser diode is turned ON aiming at a control data zone of the lead-in area of the DVD (S22). If stabilized servo is activated (S16), the tracking of the blue laser diode accesses a system data area of the optical disk to read system data. More specifically, as described later in FIGS. 6 to 11, the BP0 standard type and standard type in the part type (FIG. 11), within the physical format information (FIG. 10) in the control data zone of the system lead-in area (FIG. 7) are referred to. If this information indicates that the optical disk is HD DVD (S18), it is determined that that disk is HD DVD and following processing is carried out (S19).

Likewise, If stabilized servo is activated (S23), the tracking of the red laser diode accesses a system data area of the optical disk to read system data. More specifically, as described later in FIGS. 17 to 20, the BP0 standard type and standard type and part type within the part type (FIG. 20) within the physical format information (FIG. 18) in the control data zone of the system lead-in area (FIG. 17) are referred to. If this information indicates that the optical disk is DVD (S25), it is determined that that disk is DVD and following processing is carried out (S26).

Because the first embodiment includes two pickups, the determination operations for two kinds of laser beams can be carried out at the same time, thereby reducing needed time largely. By setting a position in which the blue LD tries tracking servo to a control data zone of the lead-in area of the HD DVD and a position in which the red LD tries tracking servo to a control zone of the lead-in area of the DVD, the needed time can be reduced further.

(System area data of HD DVD)

Data in the system area of the HD DVD will be described with reference to FIGS. 6 to 16. First, the external dimensions of a current DVD and HD DVD are compared. The allowable upper limit and allowable lower limit indicated as a range in which the dimension of the system lead-in area is in the range of ±3 with respect to the standard value of the current DVD-ROM are included in the shape range of the HD DVD. In the allowable range of each dimension in the system lead-in area of the HD DVD, the track pitch on a single layer disk is 0.52 to 0.96 μm and the minimum pit length is 0.28 to 0.52 μm. In case of two-layer disk, the track pitch is 0.52 to 0.96 μm and the minimum pit length is 0.31 to 0.57 μm. As the allowable range of the system lead-in area, these values are applied to not only reproduction specialized information recording medium but also write-once information recording medium and rewritable information recording medium.

Next, FIG. 7 shows data structure of the lead-in area in the reproduction specialized information recording medium. The lead-in area is divided to a system lead-in area and a data lead-in area across a connection area. An initial zone and a control data zone exist within the system lead-in area and a buffer zone is disposed between them. A physical sector shown in FIG. 7 is recorded in data ID, coinciding with the value of data frame number. Sector numbers at starting position of each region are noted on the right column of FIG. 7.

The data arrangement content and data arrangement order of initial zone/buffer zone/control data zone/buffer zone within the system lead-in area shown in FIG. 7 are in common structure among the reproduction specialized type, write-once type and rewritable type information recording mediums.

Next, the mechanical dimensions of the HD DVD shown in FIG. 8 coincides with the current DVD disk regardless of reproduction specialized type/write-once type/rewritable type.

FIG. 9 shows the data arrangement within the control data zone shown in FIG. 7. The structure shown in FIG. 9 is common among the reproduction specialized type, write-once type and rewritable type information recording mediums.

FIG. 10 shows the content of information within the physical format information shown in FIG. 9 of the reproduction specialized information recording medium. Information within the physical format information of the information recording medium of this embodiment has a common information from 0 byte (standard type and part version) up to 16 byte (BCA descriptor) in FIG. 10 in any of the reproduction specialized type, write-once type and rewritable type. Text or code data written in disk manufacturing information is ignored upon exchange of data.

In FIG. 10, BP0 to BP31 contains common data used for DVD family and BP32 to BP2047 are used as information of each block.

The function of each byte position is as follows.

(BP 0) standard type and part version (see FIG. 11)

Standard type:

0100b . . . HD-DVD standard to reproduction specialized disk

These bits are allocated to define a DVD standard document issued by DVD forum. They are allocated according to the following rules.

0000b: DVD standard to reproduction specialized disk

0001b: DVD standard to rewritable disk (DVD-RAM)

0010b: DVD standard to write-once disk (DVD-R)

0011b: DVD standard to re-recordable disk (DVD-RW)

0100b: HD-DVD standard to reproduction specialized disk

0101b: HD-DVD standard to rewritable disk

Others: reserve

Part version:

0000b: version 0.9 (version 0.9 is used for only test, not used for general products)

0001b: version 1.0

0100b: version 1.9 (version 1.9 is used for only test, not used for general products)

00101b: version 2.0

Others: reserve

(BP 1) disk size and maximum transmission speed of disk (see FIG. 12)

Disk size:

0000b: 12 cm disk

These bits are allocated according to the following rules.

0000b: 12 cm disk

0001b: 8 cm disk

Others: reserve

Maximum transmission speed of disk

0100b: to be determined later Mbps

These bits are allocated according to the following rules.

0000b: 2.25 Mbps

0001b: 5.04 Mbps

0010b: 10.08 Mbps

0100b: to be determined later Mbps

1111b: not specified

Others: reserve

(BP 2) disk structure (see FIG. 13)

Quantity of layers:

000b: single

01b: two layers

Others: reserve

Track pass:

0b: PTP or SL

1b: OTP

Layer type:

010Db: each bit is allocated according to the following rules.

b3:0b: emboss user data is recorded

1b: emboss user data is recorded

b2:0b: disk contains no rewritable user data area

1b: disk contains rewritable user data area

b1:0b: disk contains no recordable user data area

1b: disk contains recordable user data area

b0:0b: disk contains no emboss user data area

1b: disk contains emboss user data area

(BP 3) recording density (see FIG. 14)

Linear density (data area)

0101b: 0.153 μm/bit

These data are allocated according to the following rules.

0000b: 0.267 μm/bit

0001b: 0.293 μm/bit

0010b: 0.409 to 0.435 μm/bit

0100b: 0.280 to 0.291 μm/bit

0101b: 0.153 μm/bit

0100b: 0.130 to 0.140 μm/bit

Others: reserve

track density (data area)

0011b: 0.40 μm/track (SL disk)

0100b: 0.44 μm/track (DL disk)

These bits are allocated according to the following rules.

0000b: 0.74 μm/track

0001b: 0.80 μm/track (recordable disk)

0010b: 0.615 μm/track

0011b: 0.40 μm/track (SL disk)

0100b: 0.44 μm/track (DL disk)

0101b: 0.34 μm/track

Others: reserve

(BP 4 to BP 15) data area allocation

FIG. 15 is an explanatory diagram of the content of data area allocation information in reproduction specialized type/write-once type/rewritable type information recording mediums.

(BP 16) BCA descriptor (see FIG. 16)

This byte indicates whether or not burst cutting area (BCA) exists on a disk. Bits b6 to b0 are set in “000 0000b” and bit b7 indicates whether or not BCA exists.

These bits are allocated according to the following rules.

BCA flag:

1b: BCA exists

(BP 17 to BP 31) reserve

All bytes are set to “00h”.

(BP 32 to BP 2047) reserve

All bytes are set to “00h”.

(System area data of DVD)

Likewise, the system area data of DVD will be described with reference to FIGS. 17 to 20. FIG. 17 is an explanatory diagram showing data structure of a lead-in area of a current DVD. FIG. 18 is an explanatory diagram showing data structure within control data of the current DVD. FIG. 19 is an explanatory diagram showing the content of information within the physical format of the current DVD and FIG. 20 is an explanatory diagram showing BP0 standard type and part type of the current DVD.

In FIG. 17, the lead-in area contains control data. FIG. 18 shows that this control data contains physical format information. FIG. 19 shows that the physical format contains the standard type and part type at BP0. It is made evident that the standard type and part type have the data structure as shown in FIG. 20.

### OPTICAL DISK DEVICE ACCORDING TO AN EMBODIMENT OF THE PRESENT INVENTION

### Second Embodiment

A second embodiment relates to an optical disk device in which two diodes are prepared at a single optical pickup for different laser beams, a kind of the optical disk used last is read from its memory portion and laser beam corresponding to the type of this optical disk is irradiated so as to determine the kind of the optical disk.

(Structure)

An optical disk device 2 of the second embodiment has a single pickup PU3 loaded with a red specialized LD and a blue specialized LD in FIG. 2. That is, the optical disk device 2 has a control portion 110 which controls the entire operation and includes a determining portion about the kind of the disk and memory portion which memorizes information of an optical disk used last. This optical disk device further has a spindle motor 131 which rotates an optical disk D at a predetermined speed and a spindle motor drive circuit (not shown).

This pickup PU3 is connected to the control portion 110 and has a laser diode 120 for blue laser (405 nm) for HD DVD, a collimator lens 121, a laser diode 118 for red laser (650 nm) for DVD (780 nm for CD), a collimator lens 119, polarized beam splitters 122, 123, an objective lens 130, a condenser lens 124, a polarized beam splitter 126, a blue specialized light detector 125 and a red specialized light detector 127. This pickup PU3 further has lens actuators 128, 129 for the objective lens 130.

Here, the blue specialized laser diode driver 116 drives the laser diode 120 under the control of the control portion 110 and a detection signal is supplied from the light detector 125 to a blue specialized focus error (FE) signal generating circuit 114 and blue specialized tracking error (TE) signal generating circuit 115 and each of them supplies a focus error signal and tracking error signal to the control portion 110.

Likewise, the red specialized laser diode driver 117 drives the laser diode 118 under the control of the control portion 110 and a detection signal is supplied from the light detector 127 to a red specialized focus error (FE) signal generating circuit 112 and red specialized tracking error (TE) signal generating-circuit 113 and each of them supplies a focus error signal and tracking error signal to the control portion 110.

Although a case where this optical pickup PU3 has two light sources each having a different wavelength will be described, the quantity of laser diodes increases if three or more light sources each having a different wavelength (for example, for CD) are provided. Although as an embodiment of the respective light sources, a first wavelength is represented near 405 nm (HD DVD) and a second wavelength is represented near 660 nm (DVD), it is preferable to irradiate beam of a third wavelength near 785 nm (CD). Further, it is also preferable that the first laser beam is 440 nm or less, the second laser beam is 600 to 700 nm and the third laser beam is 700 nm or more.

In the optical pickup device PU3, blue laser beam irradiated from the blue laser diode 120 is turned to parallel light by the collimator lens 121 and focused by the objective lens 130, entering an optical disk D. The incident light from the surface of the optical disk is focused on a recording/reproduction layer face while reflected light passes through the objective lens 130 via an opposite course to the foregoing one and is reflected by the polarized beam splitter 123. The reflected light is focused by the condenser lens 124 and reflected by the polarized beam splitter 126. The reflected blue laser beam is received by the light detector 125.

The same operation is performed for the red laser beam. The red laser beam irradiated from the red laser diode 118 is turned to parallel light by the collimator lens 121, focused by the objective lens 130 and enters an optical disk D. Light incident from the surface of the optical disk and reflected passes through the objective lens 130 via an opposite route to the foregoing one and is reflected by the polarized beam splitter 123. The reflected red laser beam is received by the light detector 127.

A detection signal detected by the light detector 125 or the light detector 127 is supplied to the blue specialized FE signal generating circuit 114 and blue specialized TE signal generating circuit 115 or the red specialized FE signal generating circuit 112 and the red specialized TE signal generating circuit 113 respectively. Then, a control amount is determined by the control portion 110 depending on the magnitude of each focus error signal and each tracking error signal. This control amount is supplied to a servo control circuit 111 so as to execute focus control and tracking control of the pickup PU3 through the actuators 128 and 129. When blue laser beam is valid, the servo control of the pickup PU3 is carried out depending on the blue laser beam and when red laser beam is valid, the servo control of the pickup PU3 is carried out depending on the red laser beam.

(Determination Processing on the Kind of Optical Disk)

Next, an example of the determination processing on the kind of the optical disk according to the second embodiment will be described with reference to the related drawings. First, a disk tray (not shown) is opened/closed (S11). If a sensor 144 senses that a disk is inserted (S12), the kind of an optical disk used last is read out from the memory portion by an operation of the control portion 110 and by irradiating the laser beam of that optical disk first, the kind of the optical disk is determined.

If the kind of an optical disk used last is HD DVD (S31), the blue laser diode is turned ON (S32), and the focus of the blue laser diode is turned ON aiming at a control data zone in the lead-in area of the HD DVD (S33), and the tracking of the blue laser diode is turned ON (S34). Then, if the tracking of the blue laser diode is stabilized so that servo is activated (S35), a system data area of the optical disk is accessed so as to read system data (S36) (if the tracking of the blue laser diode is unstable over a predetermined time interval in step S35, the blue laser is extinguished and the procedure jumps to S41 in order to judge the optical disk using red laser first).

More specifically, in the system data area of the optical disk, the BP0 standard type and standard type in the part type (FIG. 11) within the physical format information (FIG. 10) in the control data zone of the system lead-in area (FIG. 7) are referred as described in FIGS. 6 to 11 (S36). If this information indicates that the optical disk is HD DVD (S37), it is determined that the disk is HD DVD and the following processing is carried out (S39). Unless this information indicates that the optical disk is HD DVD (S39), the blue laser is extinguished and the procedure jumps to S41 in order to judge the optical disk using red laser.

If the kind of an optical disk used last is DVD in step S31, the red laser diode is turned ON (S41), and the focus of the red laser diode is turned ON (S42), and the tracking of the red laser diode is turned ON aiming at a control data zone in the lead-in area of the DVD (S43). Then, if the tracking of the red laser diode is stabilized so that servo is activated (S44), a system data area of the optical disk is accessed so as to read system data (S45) (if the tracking of the red laser diode is unstable over a predetermined time interval in step S45, the red laser is extinguished and the procedure jumps to S32 in order to judge the optical disk using blue laser).

More specifically, in the system data area of the optical disk, the BP0 standard type and standard type and part type (FIG. 20) in the part type (FIG. 19) within the physical format information (FIG. 18) in the control data zone of the system lead-in area (FIG. 17) are referred as described in FIGS. 17 to 20. If this information indicates that the optical disk is DVD (S46), it is determined that the disk is DVD and a following processing is carried out (S40). Unless this information indicates that the optical disk is DVD (S46), the red laser is extinguished and the procedure jumps to S41 in order to judge the optical disk using blue laser.

Because there is a high possibility that the same optical disk as an optical disk used last is loaded again, the determination processing is carried out by irradiating laser beam corresponding to the kind of the optical disk used last. This method enables the determination processing about the kind of the optical disk to be carried out securely and rapidly by reducing the determination time. Further, by setting a position in which the blue LD tries track servo in a control data zone of the system lead-in area of the HD DVD and a position in which the red LD tries track servo in a control zone of the lead-in area of the DVD, the determination time can be reduced further.

### OPTICAL DISK DEVICE ACCORDING TO AN EMBODIMENT OF THE PRESENT INVENTION

### Third Embodiment

A third embodiment relates to an optical disk device which judges the kind of the optical disk by irradiating different laser beams from a single optical pickup at the same time and turning ON tracking corresponding to the kind of an optical disk used last. The optical disk device of the third embodiment has the same structure as that of the second embodiment and its determination processing is different in that its respective laser diodes are turned ON at the same time and tracking about the kind of the optical disk used last is turned ON first.

(Determination Processing on the Kind of Optical Disk)

An example of the determination processing on the kind of the optical disk in the optical disk device of the third embodiment will be described with reference to the drawings. According to this embodiment, first, a disk tray (not shown) is opened/closed (S11). If a sensor 144 senses that a disk is inserted, a blue laser diode and red laser diode are turned ON at the same time so as to irradiate to the optical disk (S51).

The kind of an optical disk used last is read out from the memory portion by an operation of the control portion 110 and tracking of laser beam of the optical disk is turned ON to judge the kind of the optical disk.

That is, if the kind of the optical disk used last is HD DVD (S31), focus of the blue laser diode is turned ON (S33) and tracking of the blue laser diode is turned ON aiming at a control data zone in the lead-in area of the HD DVD (S34). If the tracking of the blue laser diode is stabilized so that servo is activated (S35), a system data area of the optical disk is accessed to read system data (S36) (If the tracking of the blue laser diode is unstable over a predetermined time interval in step S35, the procedure jumps to step S41 in order to determine the kind of the optical disk using red laser).

More specifically, in the system data area of the optical disk, the BP0 standard type and standard type in the part type (FIG. 11) within the physical format information (FIG. 10) in the control data zone of the system lead-in area (FIG. 7) are referred as described in FIGS. 6 to 11 (S36). If this information indicates that the optical disk is HD DVD (S37), it is determined that the disk is HD DVD and the following processing is carried out (S39). Unless this information indicates that the optical disk is HD DVD (S39), the blue laser is extinguished and the procedure jumps to S41 in order to judge the optical disk using red laser.

If the kind of an optical disk used last is DVD in step S31, focus of the red laser diode is turned ON (S42) and tracking of the red laser diode is turned ON aiming at a control data zone in the lead-in area of the DVD (S43). If the tracking of the red laser diode is stabilized so that servo is activated (S44), a system data area of the optical disk is accessed to read system data (S45) (if the tracking of the red laser diode is unstable over a predetermined time interval in step S45, the procedure jumps to step S32 in order to judge the kind of the optical disk using blue laser beam). In the meantime, the system data area of the optical disk is the same as those of the first and second embodiments.

Because there is a high possibility that the same optical disk as an optical disk used last is loaded again, the determination processing is carried out by turning ON the tracking of laser beam corresponding to the kind of the optical disk used last. This method enables the determination processing about the kind of the optical disk to be carried out securely and rapidly by reducing the determination time as in the case of the second embodiment. Further, by setting a position in which the blue LD tries track servo in a control data zone of the system lead-in area of the HD DVD and a position in which the red LD tries track servo in a control zone of the lead-in area of the DVD, the determination time can be reduced further.

In the above-described optical disk device, each of a plurality of the pickup portions contains blue laser and red laser diodes corresponding to DVD (first disk) and HD DVD (second disk). Because laser beams are irradiated from a plurality of the pickup portions at the same time and can be processed based on a detection signal corresponding to received reflection light, the kind of a recording medium can be judged rapidly. The kind of the optical disk is determined based not only on the intensity of the reflection light but whether the kind of the optical disk is HD DVD (first disk) or DVD (second disk) can be determined securely by detecting system data in the lead-in area and interpreting the meaning of this data. In case of the DVD (second disk), a specific kind thereof such as DVD-RAM can be specified.

By a variety of the embodiments described above, those skilled in art can achieve the present invention and further imagine various modifications of these embodiments easily. Even those having no inventive power can apply the present invention to various other embodiments. Therefore, the present invention extends within a wide range not inconsistent with a disclosed principle and novel features and is not restricted to the above-described embodiments.

What is claimed is:

1. An optical disk device comprising:
a first pickup portion which irradiates a first laser beam having a first wavelength to a surface of an optical disk and receives a reflected light so as to output a first detection signal;
a second pickup portion having an independent structure from the first pickup portion, which irradiates a second laser beam having a second wavelength to the surface of the optical disk and receives a reflected light so as to output a second detection signal; and
a control portion in which with the first laser beam and the second laser beam irradiated from the first pickup portion and the second pickup portion so as to receive the first detection signal and the second detection signal, when system data of a first class disk system area is detected from the first detection signal, the optical disk is determined to be the first class disk and when system data of a second class disk system area is detected from the second detection signal, the optical disk is determined to be the second class disk so as to make control depending on a determination result.

2. The optical disk device according to claim 1, wherein the kind of the first disk is HD DVD and the kind of the second disk is DVD.

3. The optical disk device according to claim 1, further comprising:
a first servo mechanism which generates a first focus error signal and a first tracking error signal by receiving the first detection signal from the first pickup portion, executes focus control of the first pickup portion based on the first focus error signal and executes tracking control of the first pickup portion based on the first tracking error signal; and
a second servo mechanism which generates a second focus error signal and a second tracking error signal by receiving the second detection signal from the second pickup portion, executes focus control of the second pickup portion based on the second focus error signal and executes tracking control of the second pickup portion based on the second tracking error signal, wherein
the control portion, after the tracking control of the firs pickup portion is stabilized, reads system data of the first detection signal and after the tracking control of the second pickup portion is stabilized, reads system data of the second detection signal.

4. The optical disk device according to claim 1, wherein the control portion determines the kind of an optical disk by detecting information in a control data zone within a system lead-in area in the first class disk system area from the first detection signal and information in a control data zone within a system lead-in area in the second class disk system area from the second detection signal.

5. The optical disk device according to claim 1, wherein the control portion determines the kind of the disk by detecting information of BP0 standard type and part type within physical format information in a control data zone of a system lead-in area in the first class disk system area from the first detection signal and information of BP0 standard type and part type within physical format information in a control data zone of a system lead-in area in the second class disk system area from the second detection signal.

6. An optical disk device comprising:
a first pickup portion which irradiates a first laser beam having a first wavelength to a surface of an optical disk and receives a reflected light so as to output a first detection signal;
a second pickup portion having an independent structure from the first pickup portion, which irradiates a second laser beam having a second wavelength to the surface of the optical disk and receives a reflected light so as to output a second detection signal;
a memory portion which memorizes the kind of an optical disk processed last; and
a control portion which reads the kind of the optical disk processed last from the memory portion and, with the first laser beam and the second laser beam irradiated from the first pickup portion and the second pickup portion according to a processing order depending on the read kind receives the first detection signal and the second detection signal, and determines whether the optical disk is first class disk or second class disk corresponding to these signals so as to make control corresponding to a determination result.

7. The optical disk device according to claim 6, wherein the kind of the first disk is HD DVD and the kind of the second disk is DVD.

8. The optical disk device according to claim 6, further comprising:
a first servo mechanism which generates a first focus error signal and a first tracking error signal by receiving the first detection signal from the first pickup portion, executes focus control of the first pickup portion based on the first focus error signal and executes tracking control of the first pickup portion based on the first tracking error signal; and
a second servo mechanism which generates a second focus error signal and a second tracking error signal by receiving the second detection signal from the second pickup portion, executes focus control of the second pickup portion based on the second focus error signal and executes tracking control of the second pickup portion based on the second tracking error signal, wherein
the control portion reads the kind of the optical disk processed last from the memory portion and, when the kind is first class disk, turns ON the laser diode of the first pickup to determine whether or not that optical disk is the first class disk to irradiate the first laser beam and then determines whether or not that optical disk is the first class disk based on the first detection signal corresponding to a reflection light; and
when the kind read from the memory portion is second class disk, turns ON the laser diode of the second pickup to determine whether or not that optical disk is the second class disk to irradiate the second laser beam and then determines whether or not that optical disk is the second class disk based on the second detection signal corresponding to a reflection light.

9. The optical disk device according to claim 6, wherein the control portion, when tracking control of the pickup turned ON first is unstable over a predetermined time interval, turns ON the laser diode of the other pickup to execute determination processing of the kind of the optical disk.

10. The optical disk device according to claim 6, further comprising:
a first servo mechanism which generates a first focus error signal and a first tracking error signal by receiving the first detection signal from the first pickup portion, executes focus control of the first pickup portion based on the first focus error signal and executes tracking control of the first pickup portion based on the first tracking error signal; and
a second servo mechanism which generates a second focus error signal and a second tracking error signal by receiving the second detection signal from the second pickup portion, executes focus control of the second pickup portion based on the second focus error signal and executes tracking control of the second pickup portion based on the second tracking error signal, wherein
by irradiating first laser beam and the second laser beam from the first pickup portion and the second pickup portion, the control portion reads the kind of the optical disk processed last from the memory portion and, when that kind is first class disk, turns ON the focus and tracking of the first laser beam so as to determine whether or not the optical disk is the first class disk and after the tracking control is stabilized, determines that the optical disk is the first class disk based on the first detection signal corresponding to the reflection light, and
when the kind read from the memory portion is second class disk, the control portion turns ON the focus and tracking of the second laser beam so as to determine whether or not the optical disk is the second class disk and after the tracking control is stabilized, determines that the optical disk is the second class disk based on the second detection signal corresponding to the reflection light.

11. The optical disk device according to claim 10, wherein when the tracking control of a pickup for which the focus and tracking are turned ON is unstable over a predetermined time interval, the control portion turns ON the focus and tracking of the other pickup so as to execute determination processing about the kind of the optical disk.

12. The optical disk device according to claim 6, wherein when system data of a first class disk system area is detected from the first detection signal, the control portion determines that the optical disk is first class disk and when system data of a second class disk system area is detected from the second detection signal, determines that the optical disk is second class disk.

13. An optical disk determination method comprising:
irradiating a first laser beam having a first wavelength from a first pickup to a surface of an optical disk;
irradiating a second laser beam having a second wavelength from a second pickup to the surface of the optical disk simultaneously with the first laser beam;
generating a first detection signal and a second detection signal based on a reflection light;
determining that the optical disk is a first class disk when system data of a first class disk system area is detected from the first detection signal; and
determining that the optical disk is a second class disk when system data of a second class disk system area is detected from the second detection signal.

14. The optical disk determination method according to claim 13, wherein the kind of the first disk is HD DVD and the kind of the second disk is DVD.

15. The optical disk determination method according to claim 11, wherein when the first detection signal is received, a first focus error signal and a first tracking error signal are generated, focus control of the first pickup is executed based on the first focus error signal, and tracking control of the first pickup is executed based on the first tracking error signal;
when the second detection signal is received, a second focus error signal and a second tracking error signal are generated, focus control of the second pickup is executed based on the second focus error signal, and tracking control of the second pickup is executed based on the second tracking error signal; and
after the tracking control of the first pickup is stabilized, system data of the first detection signal is read and after the tracking control of the second pickup is stabilized, the system data of the second detection signal is read.

16. The optical disk determination method according to claim 11, wherein the kind of the disk is determined by detecting information in a control data zone of a system lead-in area of the first class disk system area from the first detection signal and information in a control data zone of a system lead-in area of the second class disk system area from the second detection signal.

17. The optical disk determination method according to claim 11; wherein the kind of the disk is determined by detecting information of BP0 standard type and part type within physical format information in a control data zone of a system lead-in area in the first class disk system area from the first detection signal and information of BP0 standard type and part type within physical format information in a control data zone of a system lead-in area in the second class disk system area from the second detection signal.
